(19) United States
(12) Patent Application Publication
(10) Pub. No.: US 2015/0130778 A1
(43) Pub. Date: May 14, 2015

(54) HANDHELD ELECTRONIC DEVICE AND POWER SAVING METHOD THEREOF

(71) Applicant: Wistron Corporation, New Taipei City (TW)

(72) Inventors: Xing-Long Su, New Taipei City (TW); Ming-Xing Ji, New Taipei City (TW); Ren-Wei Zhang, New Taipei City (TW)

(73) Assignee: Wistron Corporation, New Taipei City (TW)

(21) Appl. No.: 14/242,911

(22) Filed: Apr. 2, 2014

(30) Foreign Application Priority Data
Nov. 12, 2013 (CN) 201310560502.5

(51) Int. Cl. G09G 3/36

(52) U.S. Cl. CPC G09G 3/3696; G09G 2330/023
USPC 345/212

(57) ABSTRACT

A handheld electronic device comprises a display, a backlight module, a video card and a central processing unit (CPU). The display comprises first and second display regions. The backlight module comprises first and second backlight units. The first backlight unit corresponds to the first display region, and the second backlight unit corresponds to the second display region. The CPU determines whether to enter a saving power mode or a normal mode. In the saving power mode, the CPU turns off the first backlight unit and turns on the second backlight unit, and controls the video card to only flash the second display region but not the first display region. In the normal mode, the CPU turns on the first and the second backlight units, and controls the video card to flash the first and the second display regions.

This application claims the benefit of People's Republic of China Patent application Serial No. 201310560502.5, filed Nov. 12, 2013, the subject matter of which is incorporated herein by reference.

### BACKGROUND OF THE INVENTION

1. Field of the Invention

The invention relates in general to an electronic device, and more particularly to a handheld electronic device and a power saving method thereof.

2. Description of the Related Art

Along with the advance in technology, electronic device with display has gradually become a necessary tool for people in their everyday life. Examples of electronic device with display include handheld electronic device, mobile communication device, tablet PC or laptop. Of the elements of the above electronic devices, display and its backlight module are most power consuming.

Currently, the display of the electronic device is either fully turned on or fully turned off. Under such design, a large amount of energy is wasted unwittingly. For instance, when making a phone call, what the user cares about most is the accuracy of number input. However, current design illuminates the entire display including the parts not containing information. Therefore, more power will be consumed.

### SUMMARY OF THE INVENTION

The invention is directed to a handheld electronic device and a power saving method thereof.

According to one embodiment of the present invention, a handheld electronic device is provided. The handheld electronic device comprises a display, a backlight module, a video card and a central processing unit (CPU).

The display comprises a first display region and a second display region. The backlight module comprises a first backlight unit and a second backlight unit. The first backlight unit corresponds to the first display region, and the second backlight unit corresponds to the second display region. The CPU determines whether to enter a saving power mode or a normal mode. In the saving power mode, the CPU turns off the first backlight unit and turns on the second backlight unit, and controls the video card to only flash the second display region but not the first display region. In the normal mode, the CPU turns on the first backlight unit and the second backlight unit, and controls the video card to flash the first display region and the second display region.

According to another embodiment of the present invention, a power saving method of a handheld electronic device is provided. The handheld electronic device comprises a display, a backlight module and a video card. The display comprises a first display region and a second display region. The backlight module comprises a first backlight unit and a second backlight unit. The first backlight unit corresponds to the first display region, and the second backlight unit corresponds to the second display region. The power saving method comprises: determining whether to enter a saving power mode or a normal mode; in the saving power mode, turning off the first backlight unit and turning on the second backlight unit, and controlling the video card to flash only the second display region but not the first display region; in the normal mode, turning on the first backlight unit and the second backlight unit, and controlling the video card to flash the first display region and the second display region.

The above and other aspects of the invention will become better understood with regard to the following detailed description of the preferred but non-limiting embodiment(s).The following description is made with reference to the accompanying drawings.

### BRIEF DESCRIPTION OF THE DRAWINGS

FIG. 1 is a block diagram of a handheld electronic device according to an embodiment of the invention.

FIG. 2 is a 3D diagram of a display and the backlight module according to an embodiment of the invention.

FIG. 3 is a schematic diagram of a second display region displaying a phone call interface.

FIG. 4 is a schematic diagram of a second display region displaying a phonebook interface.

FIG. 5 is a flowchart of a power saving method of a handheld electronic device according to an embodiment of the invention.

### DETAILED DESCRIPTION OF THE INVENTION

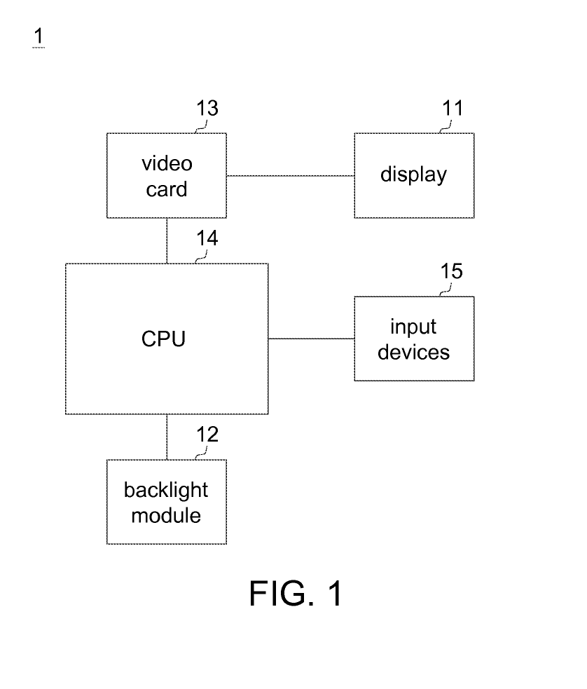

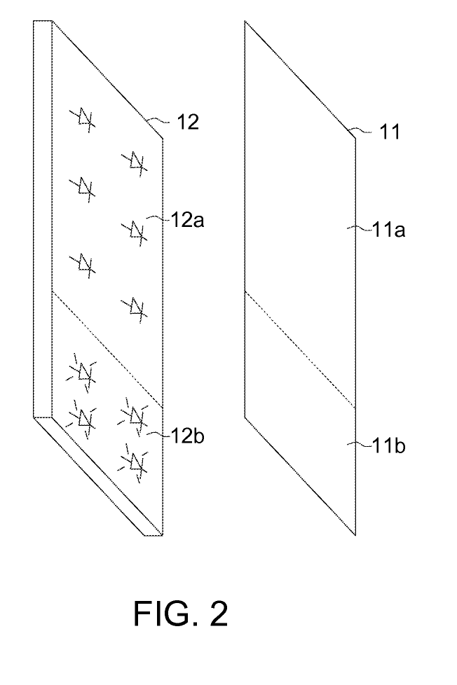

Referring to FIG. 1 and FIG. 2. FIG. 1 is a block diagram of a handheld electronic device according to an embodiment of the invention. FIG. 2 is a 3D diagram of a display and the backlight module according to an embodiment of the invention. The handheld electronic device 1, such as a mobile phone, comprises a display 11, a backlight module 12, a video card 13, a central processing unit (CPU) 14 and an input device 15. The display 11, such as a liquid crystal display (LCD), comprises a first display region 11a and a second display region 11b. The first display region 11a is larger than the second display region 11b. For instance, the first display region 11a is 3 times the area of the second display region 11b.

The backlight module 12 comprises a first backlight unit 12a and a second backlight unit 12b. The first backlight unit 12a corresponds to the first display region 11a, and the second backlight unit 12b corresponds to the second display region 11b. The backlight region of the first backlight unit 12a is larger than the backlight region of the second backlight unit 12b. For instance, the backlight region of the first backlight unit 12a is 3 times the area of the backlight region of the second backlight unit 12b. The first backlight unit 12a such as comprises a plurality of light emitting diodes (LEDs), and the second backlight unit 12b such as comprises one or more than one LED. The input device 15 is such as a physical key or a touch panel.

The CPU 14 determines whether to enter a saving power mode or a normal mode. In the saving power mode, the CPU 14 turns off the first backlight unit 12a and turns on the second backlight unit 12b through general purpose input/output pins (GPIO) (FIG. 2), and controls the video card 13 to only flash the second display region 11b but not the first display region 11a. For instance, the display 11 has a resolution of 800×600, the first display region 11a has a resolution of 600×600, and the second display region 11b has a resolution of 200×600. If the top left corner of the display 11 is defined as pixel position (0,0), then only the second display region 11b needs to be flashed, and the video card 13 only flashes the region from pixel position (0,-600) to pixel position (600,-800).

Relatively, in the normal mode, the CPU 14 turns on the first backlight unit 12a and the second backlight unit 12b through GPIOPs, and controls the video card 13 to flash the first display region 11a and the second display region 11b. In other words, the CPU 14 controls the video card 13 to flash the entire display 11. The user can trigger the saving power mode or the normal mode through the input device 15. For instance, the input device 15 comprises a first physical key and a second physical key. When the first physical key and the second physical key are pressed at the same time, the saving power mode or the normal mode is triggered. The first physical key is such as a volume key, and the second physical key is such as a power key.

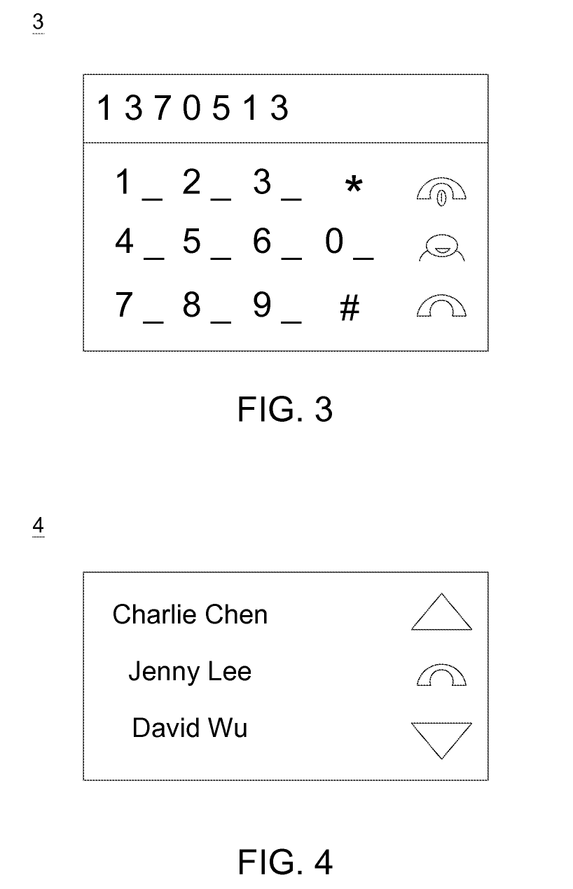

Referring to FIG. 2, FIG. 3 and FIG. 4. FIG. 3 is a schematic diagram of a second display region displaying a phone call interface. FIG. 4 is a schematic diagram of a second display region displaying a phonebook interface. Since the user does not need to use the entire display 11 when making a phone call, the second display region 11b only displays a phone call interface 3 as indicated in FIG. 3. Since the user does not need to use the entire display 11 when looking up the phonebook, the second display region 11b only displays a phonebook interface 4 as indicated in FIG. 4.

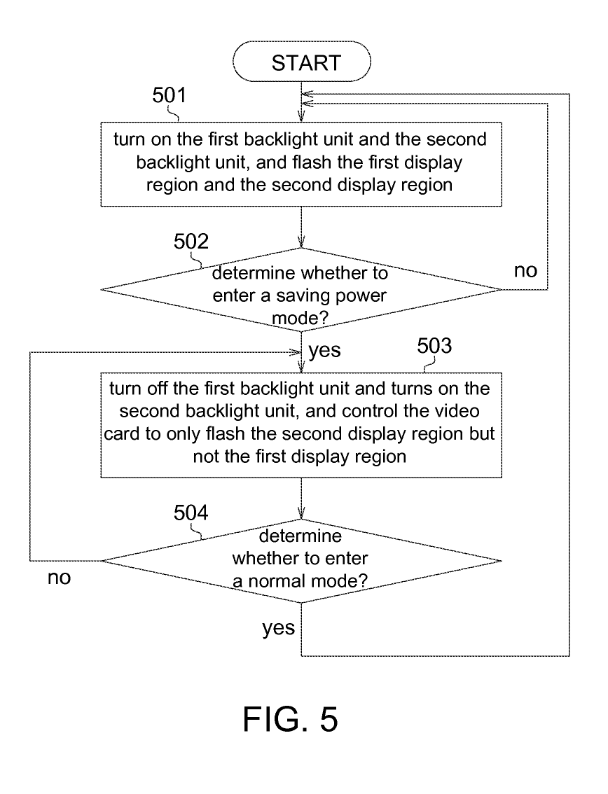

Referring to FIG. 1, FIG. 2 and FIG. 5. FIG. 5 is a flowchart of a power saving method of a handheld electronic device according to an embodiment of the invention. The power saving method of a handheld electronic device 1 comprises following steps: Firstly, the method begins at step 501, in the normal mode, the CPU 14 turns on the first backlight unit 12a and the second backlight unit 12b through GPIOPs, and controls the video card 13 to flash the first display region 11a and the second display region 11b. Next, the method proceeds to step 502, the CPU 14 determines whether to enter a saving power mode. The user can trigger the saving power mode through the input device 15. Or, after a corresponding application program is turned on, the saving power mode is automatically triggered. If the CPU does not enter the saving power mode, then step 501 is repeated.

Conversely, if the CPU enters the saving power mode, then the method proceeds to step 503. In step 503, in the saving power mode, the CPU 14 turns off the first backlight unit 12a and turns on the second backlight unit 12b through GPIOPs, and controls the video card 13 to only flash the second display region 11b but not the first display region 11a. Then, the method proceeds to step 504, the CPU 14 determines whether to enter the normal mode. The user can trigger the normal mode through the input device 15. Or, after a corresponding application program is turned off, the normal mode is automatically triggered. If the CPU enters the normal mode, then the method proceeds step 501. Conversely, if the CPU does not enter the normal mode, then the method proceeds to step 503.

Based on the user's needs, the handheld electronic device 1 disclosed in above embodiments only flashes parts of the display and turns on parts of the light emitting elements of the backlight module in the saving power mode, not only saving power but also increasing standby time.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A handheld electronic device, comprising:
a display, comprising:
a first display region; and
a second display region;
a backlight module, comprising:
a first backlight unit corresponding to the first display region; and
a second backlight unit corresponding to the second display region;
a video card; and
a central processing unit (CPU) used for determining whether to enter a saving power mode or a normal mode, wherein in the saving power mode, the CPU turns off the first backlight unit and turns on the second backlight unit, and controls the video card to only flash the second display region but not the first display region, and in the normal mode, the CPU turns on the first backlight unit and the second backlight unit, and controls the video card to flash the first display region and the second display region.

2. The handheld electronic device according to claim 1, further comprising:
an input device used for triggering the saving power mode or the normal mode.

3. The handheld electronic device according to claim 2, wherein the first display region is larger than the second display region.

4. The handheld electronic device according to claim 3, wherein the first backlight region of the first backlight unit is larger than a second backlight region of the second backlight unit.

5. The handheld electronic device according to claim 4, wherein the input device comprises:
a first physical key; and
a second physical key used for triggering the saving power mode or the normal mode when the first physical key and the second physical key are pressed at the same time.

6. A power saving method of a handheld electronic device, wherein the handheld electronic device comprises a display, a backlight module and a video card, the display comprises a first display region and a second display region, the backlight module comprises a first backlight unit and a second backlight unit, the first backlight unit corresponds to the first display region, the second backlight unit corresponds to the second display region, and the power saving method comprises:
determining whether to enter a saving power mode or a normal mode;
turning off the first backlight unit and turning on the second backlight unit in the saving power mode and only flashing the second display region but not the first display region; and
turning on the first backlight unit and the second backlight unit in the normal mode and controlling the video card by the CPU to flash the first display region and the second display region.

7. The power saving method according to claim 6, wherein the handheld electronic device further comprising:
an input device used for triggering the saving power mode or the normal mode.

8. The power saving method according to claim 7, wherein the first display region is larger than the second display region.

9. The power saving method according to claim 8, wherein the first backlight region of the first backlight unit is larger than a second backlight region of the second backlight unit.

10. The power saving method according to claim 9, wherein the input device comprises:
a first physical key; and
a second physical key used for triggering the saving power mode or the normal mode when the first physical key and the second physical key are pressed at the same time.
